(19) United States
(12) Patent Application Publication
(10) Pub. No.: US 2026/0065579 A1
(43) Pub. Date: Mar. 5, 2026

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventors: Nobuyuki MATSUMIYA, Saitama (JP); Shohei IWAMOTO, Kanagawa (JP)

(21) Appl. No.: 19/307,359

(22) Filed: Aug. 22, 2025

(30) Foreign Application Priority Data
Aug. 28, 2024 (JP) 2024-146696

(51) Int. Cl. G06T 15/20

(52) U.S. Cl. CPC G06T 15/20; G06T 2200/24

(57) ABSTRACT

A key frame setting part reads out a base virtual viewpoint path that has been generated and is stored in a virtual viewpoint path memory part. A key frame number receiving part obtains an input value as the number of key frames. A key frame setting part selects virtual viewpoint parameters of the obtained number of key frames, from the virtual viewpoint parameters of the respective frames included in the virtual viewpoint path that has been read out. A virtual viewpoint path regenerating part interpolates virtual viewpoint parameters corresponding to the respective frames between key frames, based on the virtual viewpoint parameters of the key frames that are stored in a key frame storage part.

### BACKGROUND

### Field of the Technology

The technology of the present disclosure relates to an information processing technology for generating a virtual viewpoint image.

### Description of the Related Art

There is a technology for generating a virtual viewpoint image, which represents a view from a virtual viewpoint that is virtually placed in a three-dimensional space, using a plurality of captured images obtained by a plurality of imaging apparatuses installed at different positions and capturing the same subject in a synchronous manner. In this technology, it is also possible for a viewer of a virtual viewpoint image to generate a virtual viewpoint path by themselves and distribute a virtual viewpoint image rendered based on the generated virtual viewpoint path, to other viewers. As one method for generating a virtual viewpoint path, at the time of designating time-series virtual viewpoint parameters that constitute a virtual viewpoint path, the user performs a manual operation to designate position information indicating the positions of the virtual viewpoints at short intervals, such as per frame. In the method where the user designates position information by a manual operation, it is possible to continuously input virtual viewpoint parameters corresponding to each of a plurality of consecutive frames, and thus a virtual viewpoint path can be easily generated. On the other hand, information on the positions and orientations of the virtual viewpoints designated by a manual operation of the user is stored as it is as time-series virtual viewpoint parameters that constitute the virtual viewpoint path. Therefore, there may be cases where a virtual viewpoint path involving a steep change in the positions or orientations of a virtual viewpoint, such as an unintended deviation caused by a user's operational error, is stored.

Japanese Patent Laid-Open No. 2023-173577 discloses a method for suppressing a steep change in a virtual viewpoint image by changing the playback speed of the virtual viewpoint image, in order to reduce visual motion sickness experienced by viewers due to a steep change in a generated virtual viewpoint path.

### SUMMARY

The present disclosure is characterized by including: an obtaining module configured to obtain a first virtual viewpoint path that indicates a trajectory of virtual viewpoint changes and is used for generating a virtual viewpoint image; a selecting module configured to select a plurality of virtual viewpoints included in the first virtual viewpoint path; and a generating module configured to generate a second virtual viewpoint path by interpolating between the plurality of virtual viewpoints selected by the selecting module.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of the hardware configuration of an information processing device according to an embodiment of the present disclosure;

FIG. 2 is a diagram illustrating an example of the configuration of a virtual viewpoint image generating system including an information processing device according to the first embodiment of the present disclosure;

FIG. 3 is a diagram illustrating an example of a UI for editing a virtual viewpoint path according to an embodiment of the present disclosure;

FIG. 4 is a diagram illustrating an example of a UI for regenerating a virtual viewpoint path according to the first embodiment of the present disclosure;

FIG. 5 is a flowchart for explaining the processing of regenerating a virtual viewpoint path according to the first embodiment of the present disclosure;

FIGS. 6A to 6C are diagrams illustrating an example of setting key frame information based on designated virtual viewpoint path information;

FIGS. 7A and 7B are schematic diagrams illustrating a virtual viewpoint path before and after the regeneration according to the first embodiment of the present disclosure;

FIG. 8 is a diagram illustrating an example of the configuration of a virtual viewpoint image generating system including an information processing device according to the second embodiment of the present disclosure;

FIG. 9 is a diagram illustrating an example of a UI for regenerating a virtual viewpoint path according to the second embodiment of the present disclosure;

FIG. 10 is a flowchart for explaining the processing of regenerating a virtual viewpoint path according to the second embodiment of the present disclosure;

FIG. 11 is a flowchart for explaining the processing of detecting a steep change in a regenerating section according to the second embodiment of the present disclosure;

FIG. 12 is a flowchart for explaining the processing of setting key frames excluding a steeply changing portion according to the second embodiment of the present disclosure;

FIGS. 13A to 13D are diagrams illustrating an example of setting key frame information based on designated virtual viewpoint path information;

FIGS. 14A to 14C are schematic diagrams illustrating a virtual viewpoint path before and after the regeneration according to the second embodiment of the present disclosure;

### DESCRIPTION OF THE EMBODIMENTS

In the technology disclosed in Japanese Patent Laid-Open No. 2023-173577, a virtual viewpoint path that includes unintended deviations caused by a user's operational error remains as it is in the state set by the user, and there is a problem in that a steep change in the virtual viewpoint image may occur depending on the playback speed.

Hereinafter, preferred embodiments of the present disclosure are described in detail based on the accompanying drawings. The following embodiments are not intended to limit the present disclosure, and all of the combinations of the characteristics explained in the present embodiments are not necessarily essential for the solutions provided by the present disclosure. In addition, various forms within the scope that does not depart from the gist of the present disclosure are also included in the present disclosure, and parts of the following embodiments may also be combined as appropriate.

### First Embodiment

### 1-1 Overview

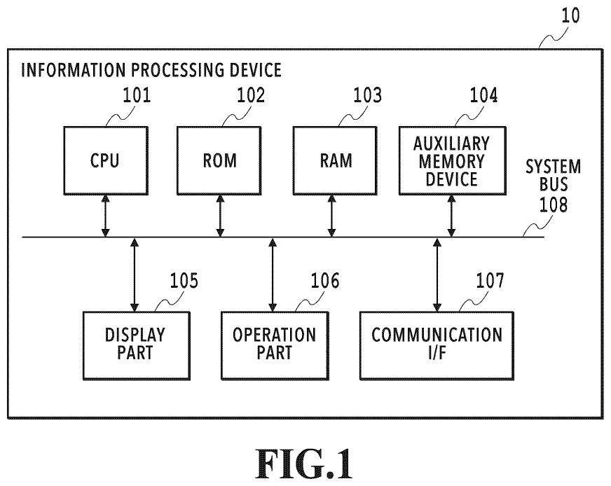

Hereinafter, with reference to FIG. 1 to FIG. 7B, a description is given about the processing of regenerating a virtual viewpoint path using the information processing device 10 according to the first embodiment of the present disclosure.

### 1-2 Configurations

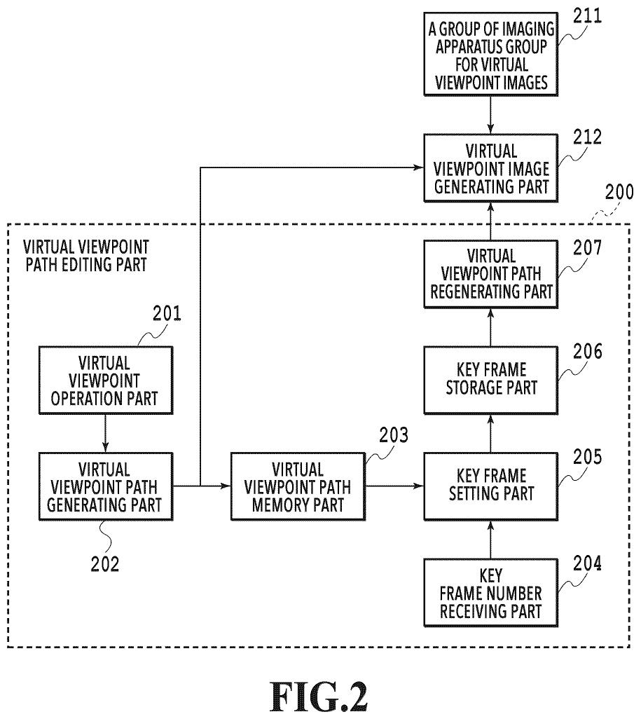

With reference to FIG. 1 and FIG. 2, a description is given about the hardware configuration and system configuration of the information processing device 10 according to the first embodiment of the present disclosure.

FIG. 1 illustrates an example of the hardware configuration of the information processing device 10 according to the first embodiment of the present disclosure. Further, FIG. 2 illustrates an example of the configuration of a virtual viewpoint image generating system including the information processing device 10 according to the first embodiment of the present disclosure.

As illustrated in FIG. 1, the hardware of the information processing device 10 includes the CPU 101, the ROM 102, the RAM 103, the auxiliary memory device 104, an input/output interface including the display part 105, the operation part 106, and the communication I/F 107, and the system bus 108.

The CPU 101 controls the entire information processing device 10, using computer programs and data stored in the ROM 102 or the RAM 103. Note that the information processing device 10 may have one or more dedicated hardware parts or GPUs different from the CPU 101, so that at least a part of the processing performed by the CPU 101 is performed by the GPU or the dedicated hardware parts. Examples of such a dedicated hardware part include an ASIC (Application Specific Integrated Circuit), a DSP (Digital Signal Processor), and the like.

The ROM 102 holds computer programs and data that do not require modification.

The RAM 103 temporarily stores computer programs and data read from the ROM 102, as well as data obtained from the outside via the communication I/F 107, and the like. The auxiliary memory device 104 is configured with, for example, a hard disk drive, etc., and stores various kinds of data such as image data and audio data.

The display part 105 is configured with, for example, a liquid crystal display, an LED, or the like, and displays a GUI and the like that allows the user to give instructions to the information processing device 10. The operation part 106 is configured with, for example, a keyboard, mouse, joystick, touch panel, and the like, and inputs various kinds of instructions to the CPU 101 in response to user's operations. The CPU 101 operates as a display control part that controls the display part 105 and as an operation control part that controls the operation part 106.

The communication I/F 107 is used for communication with devices external to the information processing device 10, such as the group of imaging apparatus group for virtual viewpoint images (211), the virtual viewpoint image generating part 212, the virtual viewpoint operation part 201, and the like, which are described later. In a case where the information processing device 10 has a function of performing wireless communication with an external device, the communication I/F 107 includes an antenna.

The system bus 108 connects each part of the information processing device 10 to transmit information.

Note that, in the present embodiment, at least one of the display part 105 and the operation part 106 may exist as a device external to the information processing device 10.

As illustrated in FIG. 2, the virtual viewpoint image generating system including the information processing device 10 includes the virtual viewpoint path editing part 200, the group of imaging apparatus group for virtual viewpoint images (211), and the virtual viewpoint image generating part 212. In the present embodiment, at least the virtual viewpoint path editing part 200 is implemented as a software configuration on the information processing device 10, and the group of imaging apparatus group for virtual viewpoint images (211) is implemented as a software configuration on the information processing device 10 or another information processing device.

The virtual viewpoint path editing part 200 includes the virtual viewpoint operation part 201, the virtual viewpoint path generating part 202, the virtual viewpoint path memory part 203, the key frame number receiving part 204, the key frame setting part 205, the key frame storage part 206, and the virtual viewpoint path regenerating part 207.

The virtual viewpoint path editing part 200 controls a virtual viewpoint and determines a series of virtual viewpoint parameters that constitute a virtual viewpoint path. The virtual viewpoint path includes time codes assigned per frame, and parameters indicating virtual viewpoint parameters associated with the time codes, and indicates a trajectory of virtual viewpoint changes. Time expressed as a time code is a one-dimensional parameter. Note that the time codes assigned per frame are determined according to the frame rate and playback speed of the virtual viewpoint image.

Virtual viewpoint parameters include parameters that indicate the position and orientation of a virtual viewpoint at least. However, the virtual viewpoint parameters are not limited to this, and may include, for example, parameters that define other elements such as a zoom and the angle of view of a virtual viewpoint. The position of a virtual viewpoint may indicate three-dimensional coordinates, and may be expressed, for example, by a three-dimensional orthogonal coordinate system with an X-axis, a Y-axis, and a Z-axis. In the present embodiment, virtual viewpoint parameters that designate the position of a virtual viewpoint are assumed to be three parameters that represent the X coordinate, the Y coordinate, and the Z coordinate in the orthogonal coordinate system. Note that the origin point of the coordinate system may be any desired position within the three-dimensional space. Further, in the present embodiment, virtual viewpoint parameters that designate the orientation of a virtual viewpoint are assumed to be three parameters that represent the angles of rotation at the virtual viewpoint about three axes (pan, tilt, roll) that are orthogonal to one another.

Therefore, a virtual viewpoint path has at least seven parameters per frame, i.e., X coordinate, Y coordinate, Z coordinate, pan, tilt, roll, and time code. The virtual viewpoint path editing part 200 can control these seven parameters.

The virtual viewpoint path editing part 200 outputs a virtual viewpoint path, which is generated based on a series of virtual viewpoint parameters input by the user, to the virtual viewpoint image generating part 212. The group of imaging apparatus group for virtual viewpoint images (211) performs synchronized image-capturing using a plurality of imaging apparatuses installed so as to surround an image-capturing target area such as a competition field, and outputs captured images, which are obtained by the image capturing, to the virtual viewpoint image generating part 212. The virtual viewpoint image generating part 212 generates a virtual viewpoint image based on the input virtual viewpoint path and captured images.

The virtual viewpoint operation part 201 samples the user input at a predetermined sampling rate, converts the sampled input values into virtual viewpoint parameters, and outputs them to the virtual viewpoint path generating part 202 as a virtual viewpoint parameter group.

The virtual viewpoint path generating part 202 generates a virtual viewpoint path by associating each virtual viewpoint parameter included in the virtual viewpoint parameter group input from the virtual viewpoint operation part 201 with a time code corresponding to a specific frame.

The virtual viewpoint path memory part 203 stores the virtual viewpoint path generated by the virtual viewpoint path generating part 202.

The key frame number receiving part 204 receives an input indicating the number of key frames from the user, and outputs it to the key frame setting part 205. Note that the number of key frames, which is selectable, is equal to or less than the number of virtual viewpoints which corresponds to the respective frames included in the base virtual viewpoint path, and, as described later, with an increase in the number of key frames, the result becomes more similar to the base virtual viewpoint path. Therefore, it is desirable that the number of key frames is smaller than the number of virtual viewpoints which corresponds to the respective frames included in the base virtual viewpoint path.

The key frame setting part 205 selects virtual viewpoint parameters corresponding to the number of key frames input to the key frame number receiving part 204 from the virtual viewpoint path stored in the virtual viewpoint path memory part 203, and sets key frame information based on the selected virtual viewpoint parameters. The key frame setting part 205 outputs the set key frame information to the key frame storage part 206. The method for setting the key frame information is described in detail later. Note that the key frame information includes the time codes of the key frames, the virtual viewpoint parameters associated with the time codes, and the playback speeds between adjacent key frames.

The key frame storage part 206 stores the key frame information output by the key frame setting part 205. The key frame information stored by the key frame storage part 206 is appropriately retrieved by the virtual viewpoint path regenerating part 207.

The virtual viewpoint path regenerating part 207 obtains key frame information from the key frame storage part 206, and regenerates a virtual viewpoint path by interpolating the virtual viewpoint parameters associated with the time codes corresponding to the frames between key frames. Note that the virtual viewpoint path is represented by virtual viewpoint parameters associated with time codes corresponding to successive frames. At the time of regenerating a virtual viewpoint path, the virtual viewpoint path regenerating part 207 associates the interpolated virtual viewpoint parameters with the time codes so that the virtual viewpoint parameters corresponding to the respective frames can be specified.

The virtual viewpoint image generating part 212 generates a three-dimensional model from the multi-viewpoint images obtained by synchronous image capturing using the group of imaging apparatus group for virtual viewpoint images (211). Further, the virtual viewpoint image generating part 212 generates virtual viewpoint images by mapping textures at the virtual viewpoints (the positions, orientations, and angles of view of the virtual viewpoints) in the virtual viewpoint path, which is generated by the virtual viewpoint path generating part 202 and the virtual viewpoint path regenerating part 207.

Note that it is also possible to use the information processing device 10 of the present disclosure for editing a virtual viewpoint path of CG images. For that end, a CG renderer is provided in place of the group of imaging apparatus group for virtual viewpoint images (211) and the virtual viewpoint image generating part 212. In this case, it is assumed that virtual viewpoints represent viewpoints placed in a CG space for generating a CG image, and can be moved to any desired position within the CG space.

### 1-3 About Virtual Viewpoint Path

A virtual viewpoint path defines the movement of a virtual viewpoint in a moving image generated by sequentially playing back a plurality of virtual viewpoint images or CG images. Such a virtual viewpoint path is managed based on frames and a timeline. A frame holds the information necessary to generate each image that constitutes a moving image. Specifically, the time (time code) of a scene and virtual viewpoint parameters are held. The time of a scene is a time that is a common reference for a captured image, and, for example, is expressed as a time code in which the time at which the game that is the image-capturing target starts is set as 00 (hour):00 (minute):00 (second):00 (frame). The number of frames included in a timeline is determined by the number of images played per second (frame rate). For example, in a case where the frame rate is 60 frames/second, the timeline includes the number of frames of 60×(the number of seconds of the timeline).

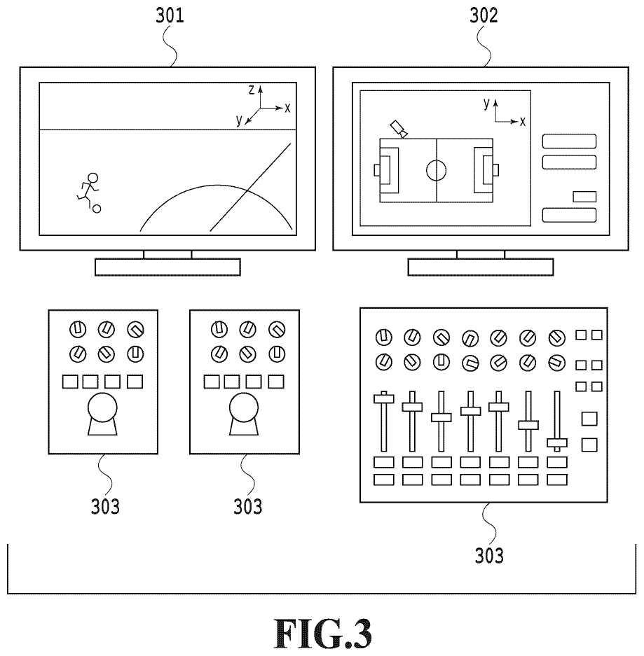

FIG. 3 illustrates an example of a UI for editing a virtual viewpoint path according to the present embodiment. The virtual viewpoint image display part 301 displays a virtual viewpoint image generated by the virtual viewpoint image generating part 212, i.e., a virtual viewpoint image representing a view from a virtual viewpoint. The GUI display part 302 displays a virtual viewpoint path, key frame information, etc. The virtual viewpoint path editing controller 303 is a controller for operating a plurality of operation axes of a virtual viewpoint, and is used by the user to edit a virtual viewpoint path.

### 1-4 Method for Setting Key Frame Information and Method for Regenerating a Virtual Viewpoint Path

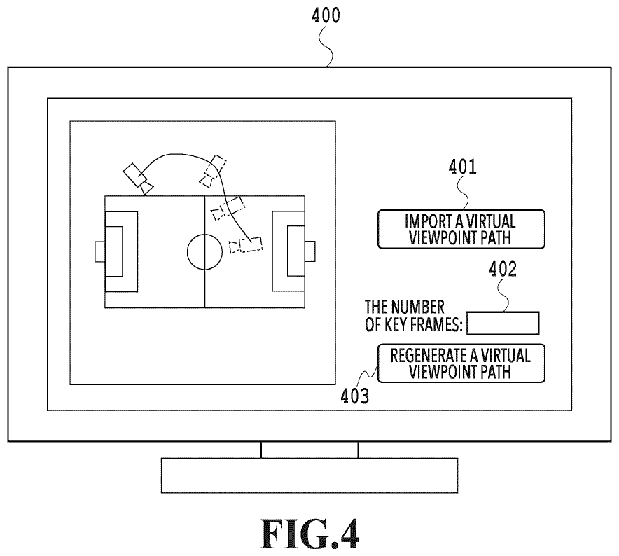

FIG. 4 illustrates an example of the UI 400 for regenerating a virtual viewpoint path in the present embodiment. The UI 400 includes the button 401, the box 402, and the button 403. If the button 401 is pressed, the virtual viewpoint path editing part 200 can read out a base virtual viewpoint path that has been generated and is stored in the virtual viewpoint path memory part 203. The key frame number receiving part 204 can receive the number of key frames from the user by obtaining the numeric value input in the box 402. If the button 403 is pressed, the virtual viewpoint path editing part 200 can regenerate a virtual viewpoint path based on the read virtual viewpoint path and the number of key frames held by the key frame number receiving part 204.

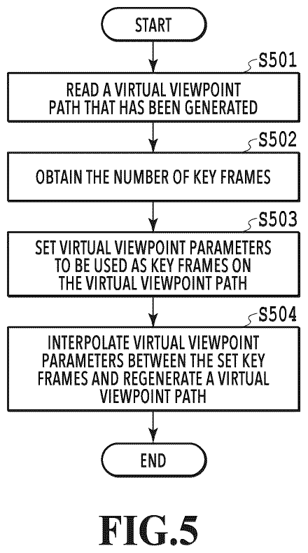

FIG. 5 illustrates a flowchart for explaining the processing of regenerating a virtual viewpoint path in the present embodiment. Note that, hereinafter, the symbol “S” in the description of the flowchart represents a step.

In S501, if the user presses the button 401 on the UI 400 illustrated in FIG. 4, the key frame setting part 205 reads out a base virtual viewpoint path that has been generated and is stored in the virtual viewpoint path memory part 203.

In S502, if the user inputs a value into the box 402 on the UI 400 illustrated in FIG. 4, the key frame number receiving part 204 obtains the input value as the number of key frames.

In S503, from the virtual viewpoint parameters per frame included in the read virtual viewpoint path, the key frame setting part 205 selects virtual viewpoint parameters for the number of key frames obtained in S502, and sets them as the virtual viewpoint parameters of the key frames. The key frame information, which includes the time codes of the key frames, the virtual viewpoint parameters, and the playback speeds, is stored in the key frame storage part 206. Note that the number of frames between key frames can be set as desired, and for example, key frames may be set so that the number of frames between key frames is constant. Further, the virtual viewpoint of the first key frame is set as the first virtual viewpoint of the read virtual viewpoint path, and the virtual viewpoint of the last key frame is set as the last virtual viewpoint of the read virtual viewpoint path.

In S504, if the button 403 illustrated in FIG. 4 is pressed, the virtual viewpoint path regenerating part 207 interpolates virtual viewpoint parameters corresponding to the respective frames between key frames, based on the virtual viewpoint parameters of the key frames stored in the key frame storage part 206. The interpolation method is spline interpolation, which uses a spline function to interpolate virtual viewpoint parameters between key frames so that the virtual viewpoint path between key frames moves along a smooth straight line or curve. Note that the interpolation method is not limited to this, and may be, for example, circular interpolation, linear interpolation, or Bezier interpolation. Therefore, the virtual viewpoint path regenerating part 207 can regenerate a virtual viewpoint path in which key frames are smoothly connected.

The above steps make it possible to regenerate a virtual viewpoint path that is smoother than an existing virtual viewpoint path, but the virtual viewpoint path regenerating part 207 may further include a step of displaying the regeneration result and allowing the user to select whether or not to redo the regeneration. In this case, if the user selects redo, the processing returns to S502, and if the user does not select redo, the processing ends. Here, as the display of the regenerated result, the regenerated virtual viewpoint path may be displayed, or a virtual viewpoint image generated using the regenerated virtual viewpoint path may be displayed.

### 1-5 Effects

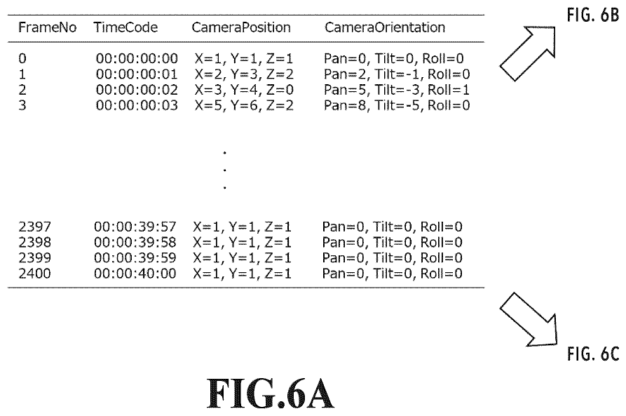

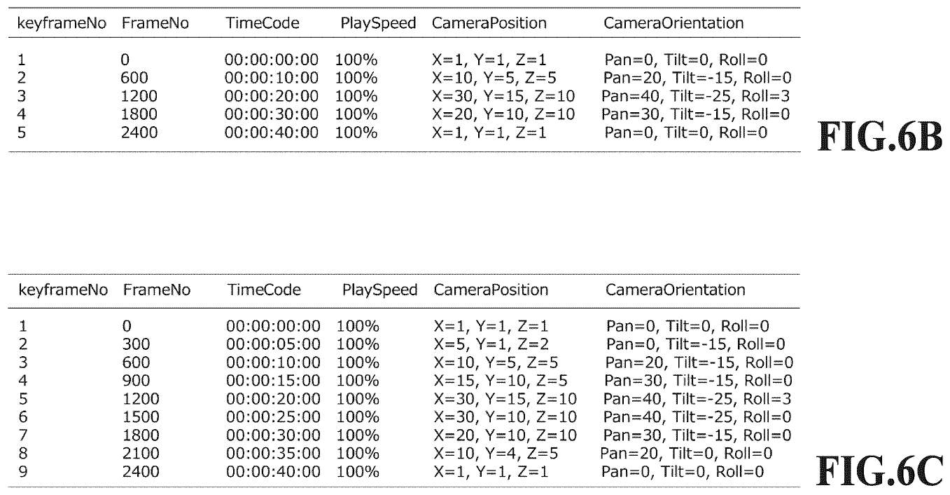

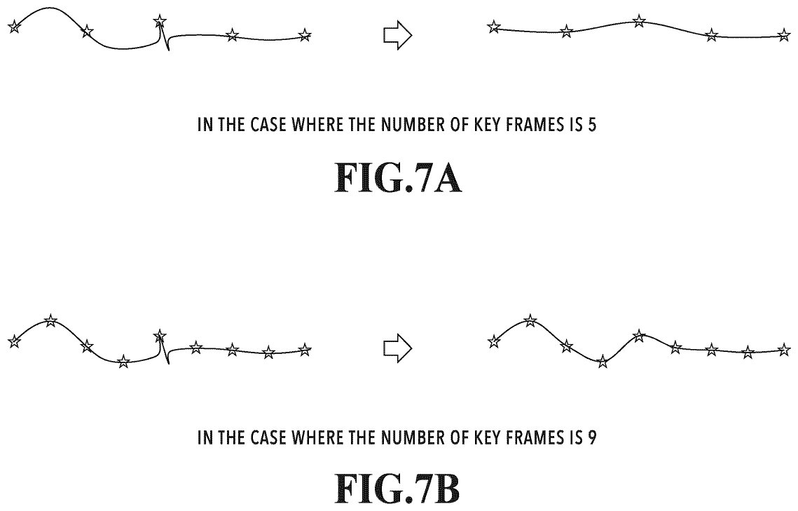

FIG. 6A to FIG. 6C illustrate an example of setting key frame information based on designated virtual viewpoint path information. FIG. 6B illustrates respective virtual viewpoint parameters corresponding to key frames that are set in a case where the number of key frames is set to 5, and FIG. 6C illustrates those in a case where the number of key frames is set to 9. FIG. 7A and FIG. 7B are schematic diagrams illustrating virtual viewpoint paths before and after regeneration in the present embodiment. FIG. 7A is a schematic diagram of a virtual viewpoint path in the case where the number of key frames is set to 5, and FIG. 7B is a schematic diagram of a virtual viewpoint path in the case where the number of key frames is set to 9.

The virtual viewpoint path illustrated in FIG. 6A includes a virtual viewpoint parameter group corresponding to 2400 frames from time code 00:00:00:00 to 00:00:40:00. Assume that there is a steep change in a virtual viewpoint parameter group corresponding to the frames numbered 1101 to 1300 among the 2400 frames.

In a case where the number of key frames is set to 5, as illustrated in FIG. 6B and FIG. 7A, five pieces of key frame information are set at intervals of 600 frames, thereby regenerating a new virtual viewpoint path in which the virtual viewpoint parameters between key frames have been interpolated based on the set key frame information.

In a case where the number of key frames is set to 9, as illustrated in FIG. 6C and FIG. 7B, nine pieces of key frame information are set at intervals of 300 frames, thereby regenerating a new virtual viewpoint path in which the virtual viewpoint parameters between key frames have been interpolated based on the set key frame information.

As described above, the virtual viewpoint path editing part 200 selects virtual viewpoint parameters corresponding to the number of key frames designated by the user, and regenerates a virtual viewpoint path in which the virtual viewpoint parameters corresponding to the frames between key frames have been interpolated. As illustrated in FIG. 7A, in a case where a small number of key frames are set, a virtual viewpoint path with gradual changes is generated, and as illustrated in FIG. 7B, in a case where a large number of key frames are set, a virtual viewpoint path that is similar to the original virtual viewpoint path is generated. This makes it possible to generate a smoothly changing virtual viewpoint path in which steep changes in virtual viewpoint images can be suppressed without affecting the playback speeds of the virtual viewpoint images, even though the base virtual viewpoint path is designated by a manual operation of the user.

### Second Embodiment

### 2-1 Overview

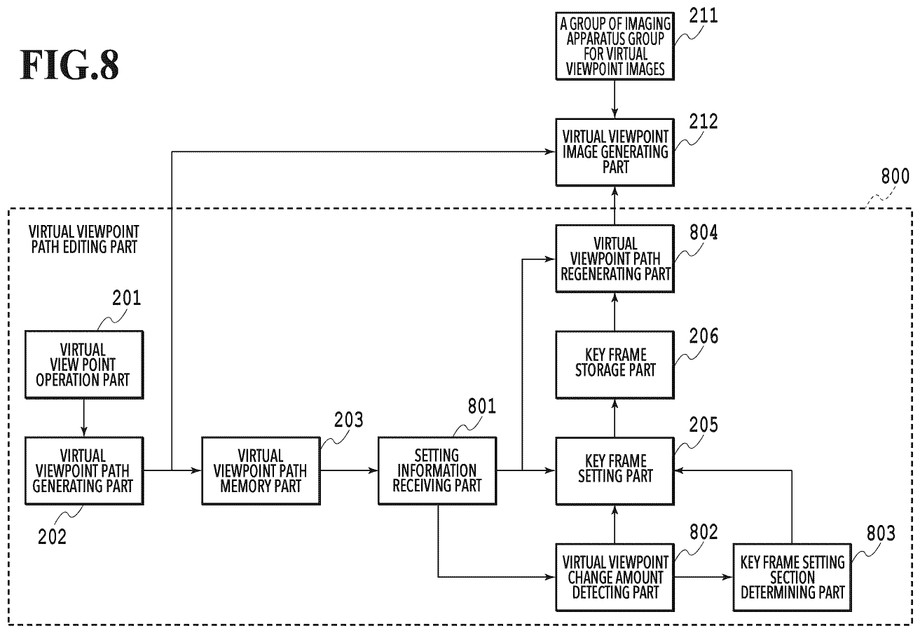

Hereinafter, with reference to FIG. 8 to FIG. 14C, a description is given about the processing of regenerating a virtual viewpoint path using the information processing device 20 according to the second embodiment of the present disclosure. The same reference numerals are given to the components that perform the same functions as those in the first embodiment, so that the descriptions thereof are omitted.

### 2-2 Configurations

FIG. 8 illustrates an example of the configuration of a virtual viewpoint image generating system including the information processing device 20 according to the second embodiment of the present disclosure. Note that the hardware configuration of the information processing device 20 is similar to that of the information processing device 10, and thus a description thereof is omitted here.

As illustrated in FIG. 8, the virtual viewpoint image generating system including the information processing device 20 includes the virtual viewpoint path editing part 800, the group of imaging apparatus group for virtual viewpoint images (211), and the virtual viewpoint image generating part 212.

The virtual viewpoint operation part 201, the virtual viewpoint path generating part 202, the virtual viewpoint path memory part 203, the key frame setting part 205, the key frame storage part 206, and the virtual viewpoint path regenerating part 207 are the same configurations as in the first embodiment regarding the virtual viewpoint path editing part 800. The virtual viewpoint path editing part 800 further includes the setting information receiving part 801, the virtual viewpoint change amount detecting part 802, and the key frame setting section determining part 803.

The virtual viewpoint path editing part 800 outputs a virtual viewpoint path, which is generated based on a series of virtual viewpoint parameters input by the user, to the virtual viewpoint image generating part 212. The group of imaging apparatus group for virtual viewpoint images (211) performs synchronized image-capturing using a plurality of imaging apparatuses installed so as to surround an image-capturing target area such as a competition field, and outputs captured images, which are obtained by the image capturing, to the virtual viewpoint image generating part 212. The virtual viewpoint image generating part 212 generates a virtual viewpoint image based on the input virtual viewpoint path and captured images.

The setting information receiving part 801 receives, from the user, setting information indicating the number of key frames, the regenerating section of a virtual viewpoint path, and whether a function to avoid setting steep sections for avoiding key frames from being set in a section where the virtual viewpoint changes steeply. The setting information receiving part 801 outputs the received setting information to the key frame setting part 205, the virtual viewpoint change amount detecting part 802, and the virtual viewpoint path regenerating part 804. Note that, in a case where the user does not set a regenerating section, the regenerating section may be set to the entire virtual viewpoint path read out from the virtual viewpoint path memory part 203, or to a section of a predetermined range including a steep section.

In a case where the function to avoid setting steep sections is enabled in the setting information receiving part 801, the virtual viewpoint change amount detecting part 802 calculates the amounts of change in the virtual viewpoint parameters of the regenerating section and detects a section in which the amount of change is equal to or greater than a predetermined threshold value as a steep section. The virtual viewpoint change amount detecting part 802 outputs the detected steep section to the key frame setting section determining part 803 in a form of a list of time codes.

The key frame setting section determining part 803 outputs, to the key frame setting part 205, a virtual viewpoint path obtained by excluding the virtual viewpoint parameters corresponding to the time codes output by the virtual viewpoint change amount detecting part 802 from the original virtual viewpoint path.

The key frame setting part 205 sets key frame information of the number of key frames for a virtual viewpoint path stored in the virtual viewpoint path memory part 203 or a regenerating section of the virtual viewpoint path input from the key frame setting section determining part 803. The number of key frames that is set here is the number of key frames input from the key frame number receiving part 204, as in the first embodiment. The key frame setting part 205 outputs the set key frame information to the key frame storage part 206.

The virtual viewpoint path regenerating part 804 obtains key frame information from the key frame storage part 206, and regenerates a virtual viewpoint path in the regenerating section by interpolating virtual viewpoint parameters associated with time codes corresponding to the frames between key frames. The virtual viewpoint path regenerating part 804 generates a new virtual viewpoint path by replacing the regenerating section of the original virtual viewpoint path with the regenerated virtual viewpoint path.

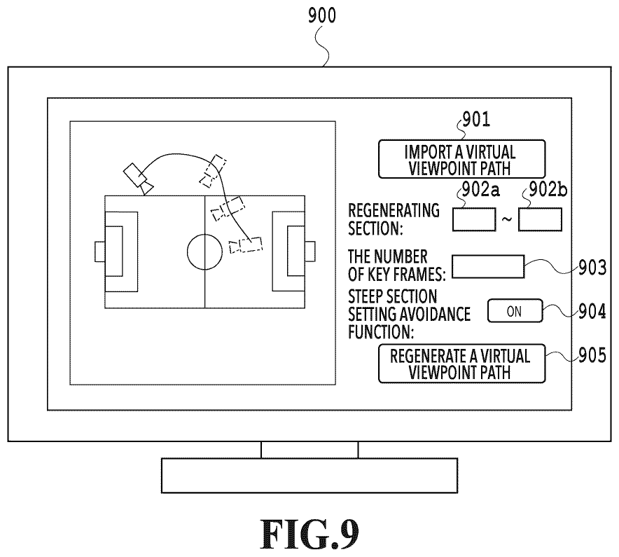

FIG. 9 illustrates an example of the UI 900 for regenerating a virtual viewpoint path in the present embodiment. The UI 900 is configured with the button 901, the box 902a, the box 902b, the box 903, the button 904, and the button 905.

If the button 901 is pressed, the virtual viewpoint path editing part 800 reads out a base virtual viewpoint path, which has been generated, from the virtual viewpoint path memory part 203. The setting information receiving part 801 can set a regenerating section by inputting the start frame and end frame of the original virtual viewpoint path into the box 902a and the box 902b. Note that any parameters that can designate a section of the read virtual viewpoint path may be used, such as time codes. The setting information receiving part 801 can set the number of key frames to be set based on the numeric value input in the box 903. If the button 904 is pressed, the setting information receiving part 801 switches between enabled/disabled of the function to avoid setting steep sections in the regenerating section. If the button 905 is pressed, the virtual viewpoint path editing part 800 regenerates a virtual viewpoint path, based on the setting values received by the setting information receiving part 801.

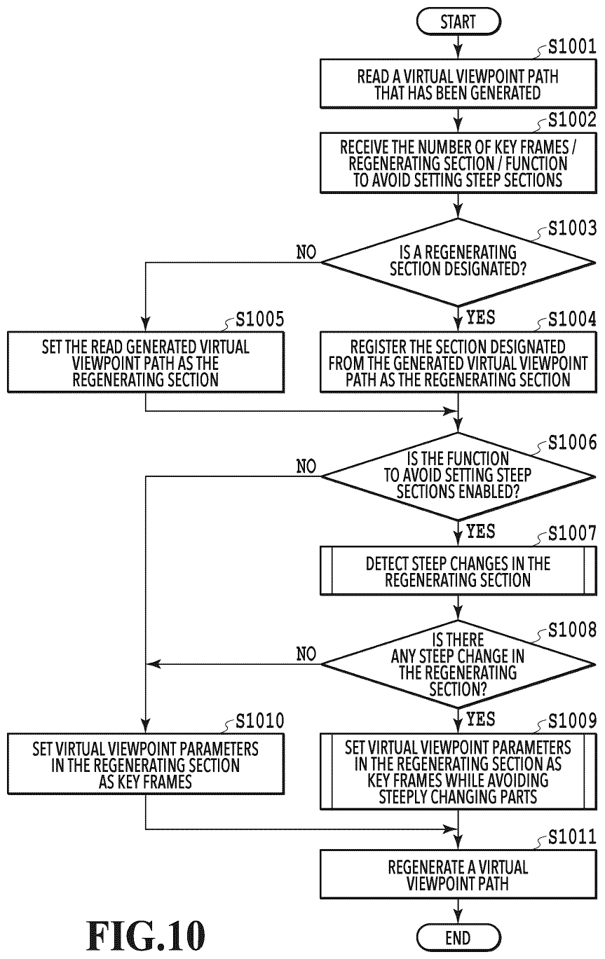

Hereinafter, with reference to FIG. 10 to FIG. 12, a description is given about the processing procedure for regenerating a virtual viewpoint path in the present embodiment.

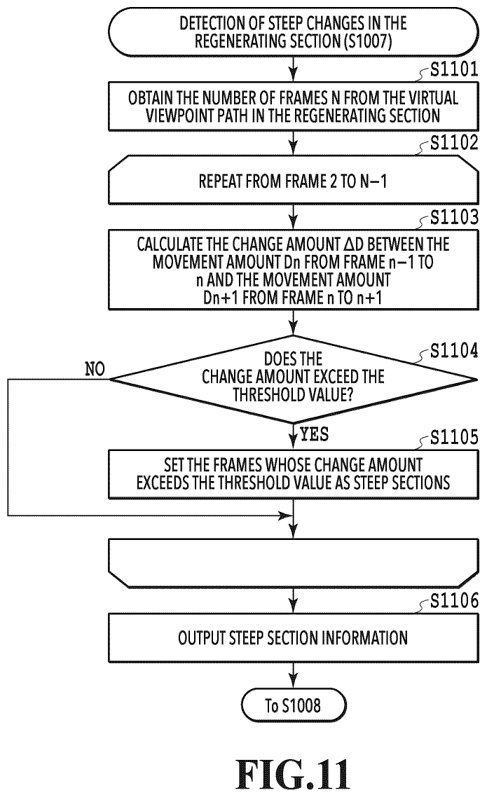

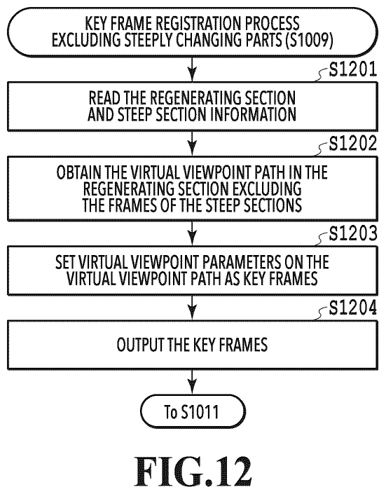

FIG. 10 illustrates a flowchart for explaining the processing of regenerating a virtual viewpoint path in the present embodiment. FIG. 11 is a flowchart for explaining the processing of detecting a steep change in a regenerating section in the present embodiment. FIG. 12 illustrates a flowchart for explaining the processing of setting key frames excluding a steeply changing portion in the present embodiment. Note that, hereinafter, the symbol “S” in the description of the flowchart represents a step.

In S1001, if the user presses the button 901, the virtual viewpoint path editing part 800 designates a base virtual viewpoint path that has been generated and is stored in the virtual viewpoint path memory part 203.

In S1002, the setting information receiving part 801 receives the number of key frames to be set, a regenerating section, and whether the function to avoid setting steep sections is enabled or disabled.

In S1003, the setting information receiving part 801 determines whether or not a regenerating section is designated. If a regenerating section is designated, the processing proceeds to S1004, and if not, the processing proceeds to S1005.

In S1004, the setting information receiving part 801 sets the virtual viewpoint path of the designated section in the original virtual viewpoint path as a regenerating section.

In S1005, the setting information receiving part 801 sets the entire original virtual viewpoint path as a regenerating section.

In S1006, the setting information receiving part 801 determines whether the function to avoid setting steep sections is enabled or disabled. If the function to avoid setting steep sections is enabled, the processing proceeds to S1007, and if not, the processing proceeds to S1010.

In S1007, the virtual viewpoint change amount detecting part 802 detects steep changes within the regenerating section. The details of the process of S1007 are described later with reference to FIG. 11.

In S1008, the virtual viewpoint change amount detecting part 802 determines whether or not there is a steep change. In a case where a steep section is obtained in S1007, the processing proceeds to S1009, and if not, the processing proceeds to S1010.

In S1009, the key frame setting section determining part 803 sets the virtual viewpoint parameters corresponding to the set number of key frames from the virtual viewpoint parameter group of the regenerating section excluding the steeply changing section from the base virtual viewpoint path. The details of the process of S1009 are described later with reference to FIG. 12.

In S1010, the key frame setting part 205 selects virtual viewpoint parameters corresponding to the key frames such that the frames in the regenerating section are equally divided by the number of key frames read out, and sets key frame information based on the selected virtual viewpoint parameters. The key frame setting part 205 stores the set key frame information in the key frame storage part 206. Note that the first key frame corresponds to the time code and virtual viewpoint parameters of the first frame in the regenerating section, and the last key frame corresponds to the time code and virtual viewpoint parameters of the last frame in the regenerating section. Note that the method for setting key frames does not necessarily require equal division, and for example, division may be performed such that the number of frames between key frames becomes a predetermined number of frames.

In S1011, if the button 905 is pressed, the virtual viewpoint path regenerating part 207 interpolates virtual viewpoint parameters corresponding to the frames between key frames, based on the virtual viewpoint parameters of the key frames stored in the key frame storage part 206. In a case where the regenerating section is set as part of the base virtual viewpoint path, the virtual viewpoint path regenerating part 207 replaces the virtual viewpoint parameter group of the regenerating section of the base virtual viewpoint path with the virtual viewpoint parameter group of the regenerated virtual viewpoint path. Since the first and last frames of the regenerating section are set as key frames, a virtual viewpoint path can be regenerated with smooth connections even between the frames of the original virtual viewpoint path and the regenerated virtual viewpoint path.

Hereinafter, with reference to FIG. 11, a description is given about the details of the processing of detecting a steep change in the regenerating section in S1007.

In S1101, the virtual viewpoint change amount detecting part 802 obtains the number of frames N of the virtual viewpoint path set in the regenerating section.

In S1102, the virtual viewpoint change amount detecting part 802 performs the processes of S1103 to S1105 on the virtual viewpoint parameters corresponding to the (n−1)th to (n+1)th frames in the virtual viewpoint path set in the regenerating section. Here, n is an integer from 2 to N−1.

In S1103, the virtual viewpoint change amount detecting part 802 calculates the time codes of the (n−1)th frame and the nth frame and the movement amount Dn in the positions of the virtual viewpoints corresponding to these frames. Similarly, the time codes of the nth frame and the (n+1)th frame and the movement amount Dn+1 in the positions of the virtual viewpoints corresponding to these frames are calculated. Further, the virtual viewpoint change amount detecting part 802 calculates the change amount ΔD (=Dn+1−Dn) which is the difference between these movement amounts per frame. Note that the herein-described change amount ΔD is not limited to the difference between the movement amounts in the positions of virtual viewpoints, but may be the difference between the change amounts in the orientations of virtual viewpoints.

In S1104, the virtual viewpoint change amount detecting part 802 determines whether the difference ΔD between the movement amounts exceeds a predetermined threshold value. If the difference ΔD between the movement amounts exceeds the predetermined threshold value, the processing proceeds to S1105, and if ΔD does not exceed the predetermined threshold value, the processing returns to S1102.

In S1105, the virtual viewpoint change amount detecting part 802 sets a frame whose difference ΔD between the movement amounts exceeds the predetermined threshold value as a steep section. The processes of S1103 to S1105 are repeated until n reaches N−1.

In S1106, the virtual viewpoint change amount detecting part 802 outputs frame information that is set as a steep section, and the processing returns to S1008.

Hereinafter, with reference to FIG. 12, a description is given about the details of the process in S1009 for setting virtual viewpoint parameters of a regenerating section as virtual viewpoint parameters corresponding to the key frames such that steep sections are avoided.

In S1201, the key frame setting section determining part 803 obtains the regenerating section and steep section information.

In S1202, the key frame setting section determining part 803 obtains a virtual viewpoint path excluding the virtual viewpoint parameters corresponding to the frames of steep sections from the regenerating section.

In S1203, the key frame setting section determining part 803 obtains the number of frames of the virtual viewpoint path excluding the virtual viewpoint parameters corresponding to the frames of the steep sections, and sets key frame information in the same manner as in S1010.

In S1204, the key frame setting section determining part 803 outputs the key frame information, and the processing returns to S1011.

### 2-3 Effects

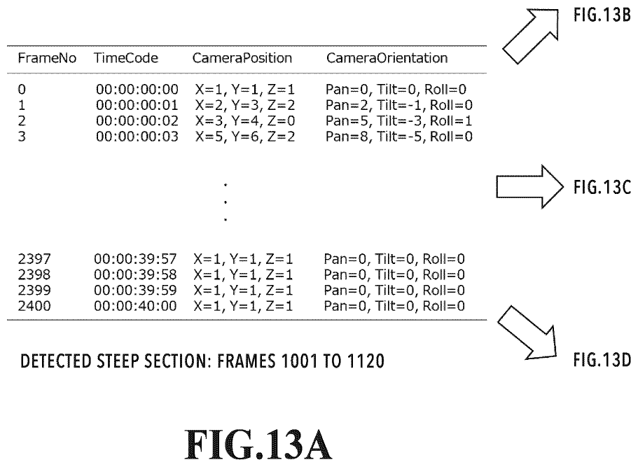

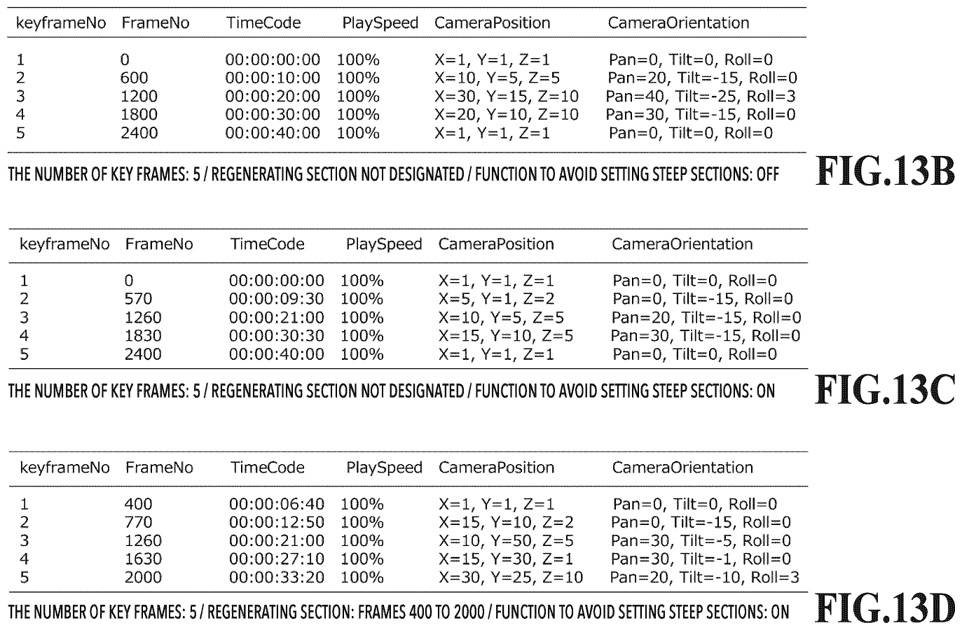

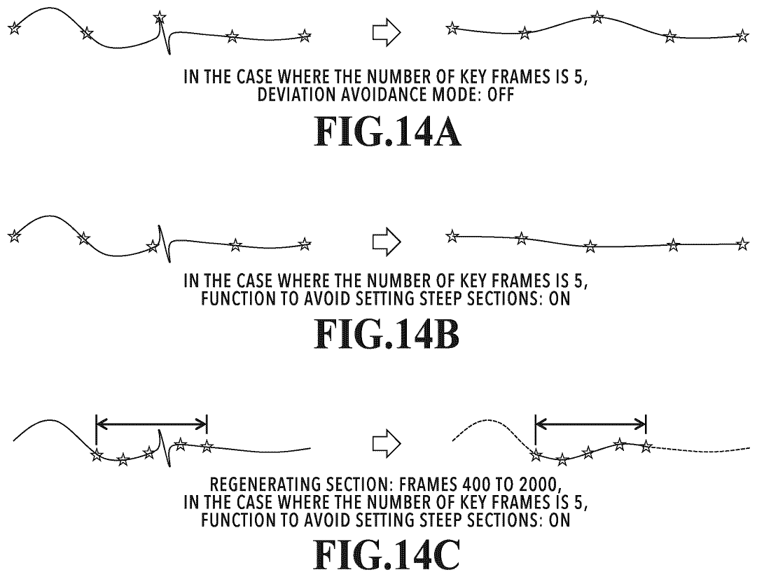

With reference to FIG. 13A to FIG. 14C, a description is given about the effects of the present embodiment, using a specific example.

FIG. 13A to FIG. 13D are diagrams illustrating an example of setting key frame information based on designated virtual viewpoint path information. FIG. 13B illustrates a case in which a regenerating section is not set and the function to avoid setting steep sections is set to disabled, and FIG. 13C illustrates a case in which a regenerating section is not set and the function to avoid setting steep sections is set to enabled. FIG. 13D illustrates a case in which a regenerating section is set and the function to avoid setting steep sections is set to enabled. The case in which the number of key frames is set to 5 is assumed in all of FIG. 13B to FIG. 13D. FIG. 14A to FIG. 14C are diagrams illustrating the effects of the regeneration of a virtual viewpoint path in the present embodiment. It is assumed that the settings in FIG. 14A to FIG. 14C are the same as those in FIG. 13B to FIG. 13D, respectively.

It is assumed that the designated virtual viewpoint path as illustrated in FIG. 13A corresponds to a virtual viewpoint parameter group of 2400 frames from time code 00:00:00:00 to 00:00:40:00.

As illustrated in FIG. 13B, in a case where the number of key frames is set to 5, five pieces of key frame information are set at intervals of 600 frames. As illustrated in FIG. 14A, the virtual viewpoint path regenerating part 804 interpolates virtual viewpoint parameters corresponding to the frames between key frames, based on the set key frame information, thereby generating a new virtual viewpoint path for the entire section of the base virtual viewpoint path.

A description is given about such a case as illustrated in FIG. 13C, in which the number of key frames is set to 5 and the function to avoid setting steep sections is enabled. For example, if the steep section detected in S1007 is composed of the 120 frames from 1001 to 1120, the key frames are set to the 0th, 570th, 1260th, 1830th, and 2400th frames of the base virtual viewpoint path. In this case, since the key frames are set to frames excluding steep sections, the positions of the key frames are different from those that are set in the case of FIG. 13B. As illustrated in FIG. 14B, the virtual viewpoint path regenerating part 804 interpolates virtual viewpoint parameters corresponding to the frames between key frames, based on the set key frame information, thereby generating a new virtual viewpoint path for the entire section of the base virtual viewpoint path.

A description is given about such a case as illustrated in FIG. 13D, in which a regenerating section is designated, the number of key frames is set to 5, and the function to avoid setting steep sections is enabled. The virtual viewpoint change amount detecting part 802 extracts a virtual viewpoint parameter group of a regenerating section that is set in the base virtual viewpoint path. If the steep section corresponds to the frames 1001 to 1120 and the regenerating section corresponds to the frames 400 to 2000, the key frames are set to the 400th, 770th, 1260th, 1630th, and 2000th frames of the base virtual viewpoint path.

As illustrated in FIG. 14C, the virtual viewpoint path regenerating part 804 interpolates virtual viewpoint parameters corresponding to the frames between key frames, based on the set key frame information, thereby generating a new virtual viewpoint path. The virtual viewpoint path regenerating part 804 connects the generated virtual viewpoint path of the regenerating section to a virtual viewpoint path outside the regenerating section of the base virtual viewpoint path, thereby generating a new virtual viewpoint path.

As described above, the virtual viewpoint path editing part 800 sets any desired number of key frames for a partial section of a base virtual viewpoint path, and interpolates virtual viewpoint parameters corresponding to the frames between key frames, thereby regenerating a virtual viewpoint path. In this way, since the interpolation process can be applied only to a portion that is unintentionally designated, the section that is intentionally designated is not changed, and it is possible to generate a virtual viewpoint path in which steep changes in the virtual viewpoint images are suppressed, without affecting the settings of the playback speeds of the virtual viewpoint images.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to generate a virtual viewpoint path in which a virtual viewpoint changes smoothly.

This application claims the benefit of Japanese Patent Application No. 2024-146696, filed Aug. 28, 2024, which is hereby incorporated by reference herein in its entirety.

What is claimed is:

1. An information processing device comprising
at least one memory and at least one processor which function as:
an obtaining module configured to obtain a first virtual viewpoint path that indicates a trajectory of virtual viewpoint changes and is used for generating a virtual viewpoint image;
a selecting module configured to select a plurality of virtual viewpoints included in the first virtual viewpoint path; and
a generating module configured to generate a second virtual viewpoint path by interpolating between the plurality of virtual viewpoints selected by the selecting module.

2. The information processing device according to claim 1,
wherein the virtual viewpoint changes are changes in at least one of positions and orientations of the virtual viewpoints.

3. The information processing device according to claim 1,
wherein the number of the virtual viewpoints selected by the selecting module is smaller than the number of the virtual viewpoints included in the first virtual viewpoint path.

4. The information processing device according to claim 1,
wherein the selecting module selects a range of the first virtual viewpoint path, from which the plurality of virtual viewpoints is selected.

5. The information processing device according to claim 4,
wherein the generating module replaces the range of the first virtual viewpoint path, which is selected by the selecting module, with the generated second virtual viewpoint path.

6. The information processing device according to claim 1 further comprising
a receiving module configured to receive a user input that designates the number of virtual viewpoints to be selected by the selecting module.

7. The information processing device according to claim 6,
wherein the receiving module includes an operating module configured to operate a plurality of manipulation axes of a virtual viewpoint placed in a three-dimensional space.

8. The information processing device according to claim 1 further comprising
a detecting module configured to detect a section with a steep change in the first virtual viewpoint path, the change in the first virtual viewpoint path exceeding a predetermined magnitude,
wherein the selecting module selects the plurality of virtual viewpoints in a section of the first virtual viewpoint path that is different from the section with the steep change detected by the detecting module.

9. The information processing device according to claim 1,
wherein the generating module performs interpolation between the plurality of virtual viewpoints, using any one of spline interpolation, arc interpolation, linear interpolation, and Bézier interpolation.

10. An information processing method comprising:
a step for obtaining a first virtual viewpoint path that indicates a trajectory of virtual viewpoint changes in a virtual viewpoint image;
a step for selecting a plurality of virtual viewpoints included in the first virtual viewpoint path; and
a step for generating a second virtual viewpoint path by interpolating between the plurality of virtual viewpoints selected in the step for selecting.

11. A non-transitory computer readable storage medium storing a program for causing a computer to perform an information processing method, the information processing method comprising:
a step for obtaining a first virtual viewpoint path that indicates a trajectory of virtual viewpoint changes in a virtual viewpoint image;
a step for selecting a plurality of virtual viewpoints included in the first virtual viewpoint path; and
a step for generating a second virtual viewpoint path by interpolating between the plurality of virtual viewpoints selected in the step for selecting.
